(19) United States
(12) Patent Application Publication
(10) Pub. No.: US 2009/0235509 A1
(43) Pub. Date: Sep. 24, 2009

(54) Tool-Less Television Stand

(76) Inventor: LAWRENCE J. BEGER, CHICAGO, IL (US)

Correspondence Address: CARDINAL LAW GROUP, Suite 2000, 1603 Orrington Avenue, Evanston, IL, 60201, US

(21) Appl. No.: 12/402,245

(22) Filed: Mar. 11, 2009

Related U.S. Application Data
(60) Provisional application No. 61/038,332, filed on Mar. 20, 2008.
(60) Provisional application No. 61/085,269, filed on Jul. 31, 2008.

(51) Int. Cl. B23P 11/00; F16M 13/00; F16M 11/00

(52) U.S. Cl. 29/428; 248/158; 248/176.1

(57) ABSTRACT

A television stand includes a first portion with a reception hole and a second portion including a male portion sized to fit within the reception hole. The second portion is rotated by contact between the male portion and reception hole as the second portion is axially moved into the reception hole.

### RELATED APPLICATIONS

This application claims the benefit of, and priority to, U.S. Provisional Patent Application 61/038,332 filed Mar. 20, 2008 and U.S. Provisional Patent Application 61/085,269 filed Jul. 31, 2008, the entirety of each of which is incorporated by reference herein.

### FIELD OF THE INVENTION

The present invention generally relates to television stands. More specifically, the invention is directed to a tool-less television stand.

### BACKGROUND OF THE INVENTION

Current video monitor technology is moving rapidly to flat screens. LCD and plasma screens are popular flat screen products. These flat screens can be mounted in a traditional manner on a horizontal surface by placement on a stand. These stands can be constructed from multiple pieces and assembled prior to distribution, but such stands are typically relatively expensive due, at least in part, to exorbitant shipping costs, as well as the need for significant shelf or floor space at a retailer. Other stands are shipped in pieces, and can be assembled by the ultimate consumer. These assembly stands are typically less expensive due to their improved shipping considerations (shipped flat and in a smaller volume of space), but can be less desirable to a consumer who then must spend time assembling the stand. Often, the consumer may become quite frustrated by the process of assembly. Other problems arise when a single piece is missing from the package, preventing satisfactory assembly and contributing to increased costs to the manufacturer, both in customer dissatisfaction, but also in the need to respond to consumer complaints, and to resolve consumer complaints.

It is an object of this invention, therefore, to overcome the deficiencies and obstacles described above.

### SUMMARY OF INVENTION

One embodiment of the invention provides stand for a television. The stand includes a first support including a planar surface and a base surface opposing the planar surface. The base surface includes a plurality of reception holes, and each reception hole includes at least a first portion and second portion. The first portion is in fluidic communication with the second portion and an ambient environment and the first portion defines a first portion axis. The second portion defines a second portion axis such that the first portion axis defines an angle with respect to the second portion axis that is greater than zero and less than 180 degrees. Additionally, the stand includes at least a first leg including a male portion at a first end of the first leg. The first leg includes a first diameter and the male portion includes a second diameter, the second diameter smaller than the first diameter. The second diameter is sized to fit within at least one of the reception holes. The male portion includes at least a first prong extending radially from the male portion. The first prong is sized to translate axially and laterally along the first portion and axially along the second portion.

Another embodiment of the invention provides a television stand that includes a first portion with a reception hole and a second portion including a male portion sized to fit within the reception hole. The second portion is rotated by contact between the male portion and reception hole as the second portion is axially moved into the reception hole.

Yet another aspect of the invention provides a method for assembling a television stand. The method includes receiving at least a first leg in a reception hole of a first support and translating the first leg along a first portion in a first axial direction and a lateral direction. Additionally, the method includes translating the first leg along a second portion in a second axial direction, the second axial direction substantially opposing the first axial direction, such that the second portion substantially restricts lateral translation.

The aforementioned and other features and advantages of the invention will become further apparent from the following detailed description of the presently preferred embodiments, read in conjunction with the accompanying drawings. The detailed description and drawings are merely illustrative of the invention rather than limiting the scope of the invention being defined by the appended claims and equivalents thereof.

### BRIEF DESCRIPTION OF THE DRAWINGS

FIG. 1 is a perspective view of an stand for a television, in accordance with one embodiment of the invention;

FIGS. 2-5 are perspective view of stand for a television in various stages of assembly, in accordance with the invention;

FIG. 6 is a flowchart illustrating one embodiment of a method in accordance with one aspect of the invention;

FIGS. 7-16 illustrate assembly drawings for a television stand and assembly instructions for a television stand in accordance with the invention;

FIGS. 17-19 illustrate perspective views of a television stand assembled in accordance with the invention; and

FIGS. 20-23 illustrate assembly drawings for a television stand in accordance with another embodiment of the invention.

### DETAILED DESCRIPTION OF THE PREFERRED EMBODIMENTS

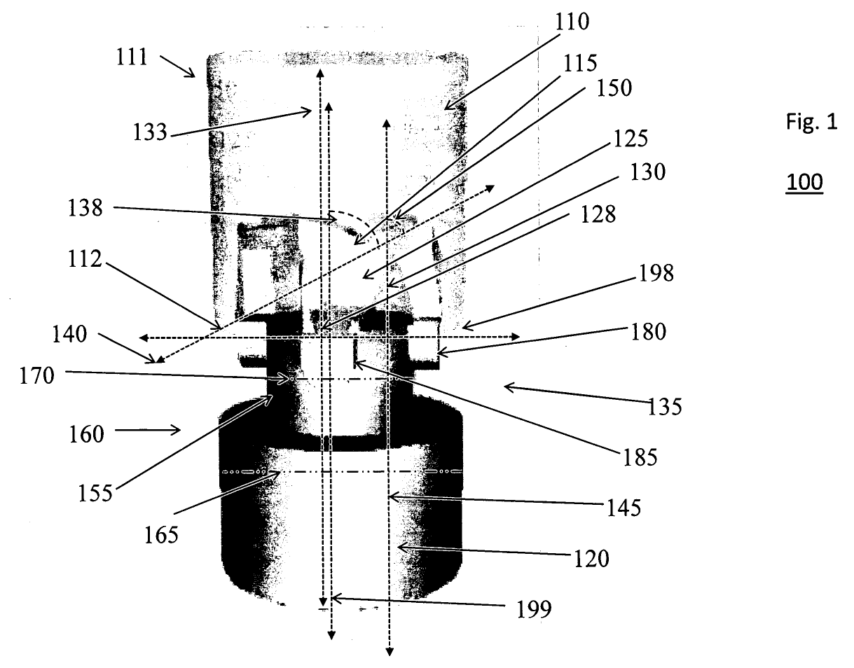

FIG. 1 illustrates one embodiment of a stand 100 for a television. The stand includes a first support 110 including a planar surface 111 and a base surface 112 opposing the planar surface, the base surface 112 including a plurality of reception holes 115, wherein each reception hole 115 includes at least a first portion 125 and second portion 130, the first portion 125 in fluidic communication with the second portion 130 and an ambient environment 135, the first portion 125 defining a first portion axis 140 and the second portion 130 defining a second portion axis 145 such that the first portion axis 140 defines an angle 150 with respect to the second portion axis 145 that is greater than zero and less than 180 degrees.

In addition, stand 100 includes at least a first leg 120. First leg 120 includes a male portion 155 at a first end 160 of the first leg 120. First leg 120 includes a first diameter 165 and the male portion 155 includes a second diameter 170, the second diameter 170 smaller than the first diameter 165, the second diameter 170 sized to fit within at least one of the reception holes 115. Male portion 155 includes at least a first prong 180 extending radially from the male portion 155, the first prong 185 sized to translate axially and laterally along the first portion 125 and axially along the second portion 130.

In one embodiment, at least one of the reception holes 115 further includes at least a third portion 128, the third portion 128 in fluidic communication with the first portion 125, and wherein the third portion 128 includes a third portion axis 133, the third portion axis 133 defining an angle 138 with respect to the first portion axis 140 that is greater than zero and less than 180 degrees.

In one embodiment, male portion 155 includes a second prong 180, the first prong 185 and second prong 180 spaced apart from each other, and wherein the first prong 185 defines a first prong axis substantially perpendicular to a first leg axis 199, and the second prong 180 defines a second prong axis 198 substantially perpendicular to the first leg axis 199, and wherein the second prong 180 is sized to translate axially and laterally along the first portion 125 and axially along the second portion 130.

In one embodiment, at least one of the first prong 185 and second prong 180 include a first side, second side, third side, and fourth side, such that the second side and third side are substantially linear and opposing, while the first side is substantially linear and opposes an arcuate fourth side. Any desired number of prongs can radially extend from the male portion, but in one embodiment, four prongs extend, and interface with the reception hole. In one embodiment, four legs interface with four reception holes.

In one embodiment, the first support includes at least one base hole in the planar surface for receiving at least one additional leg. In such embodiments, additional supports can be added to form a multi-support television stand, with each support matching with a predetermined number of legs (such as four), each each of the legs and supports being similarly constructed. In one embodiment, additional geometric configurations can be formed with differing dimensions of the supports and different arrangements.

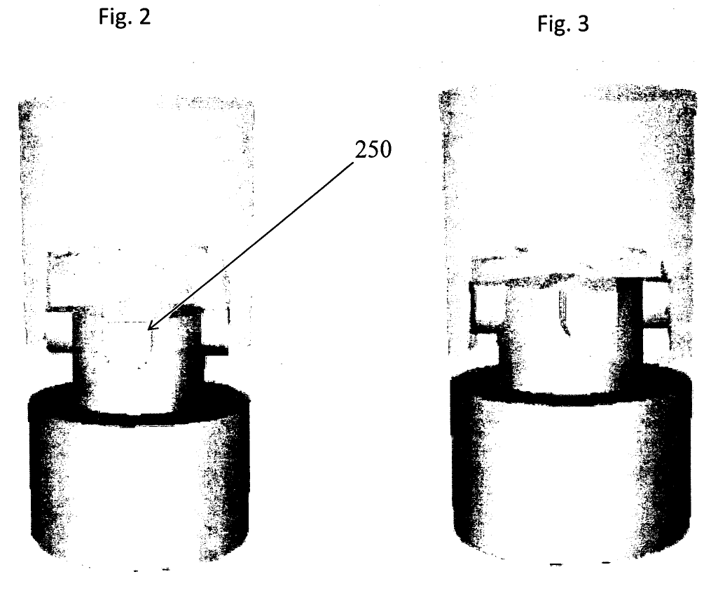

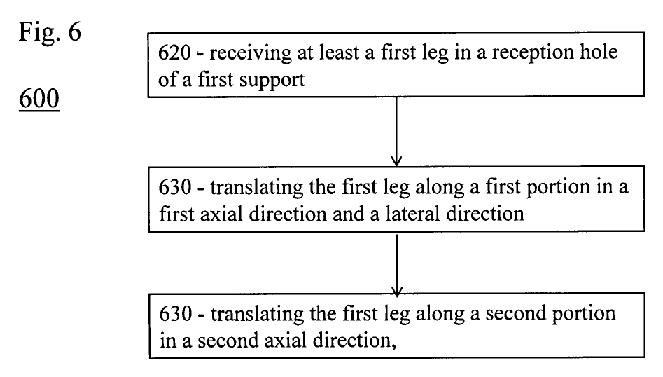

In one embodiment, the first portion 125 translates the first prong 185 from a first position 250 (FIG. 2) to a second position 655 (FIG. 6) laterally offset from the first position and the second portion substantially restricts lateral movement of the first prong 185. In one embodiment, the width of the second portion is configured to closely match the width of the prong. In one embodiment, the depth of the second portion is configured to exceed at least one half of the height of the prongs.

In one embodiment, first portion 125 has a variable interior dimension. In one embodiment, first portion 125 includes a first tapered wall and a second tapered wall such that the taper of the first tapered wall and second tapered wall are different.

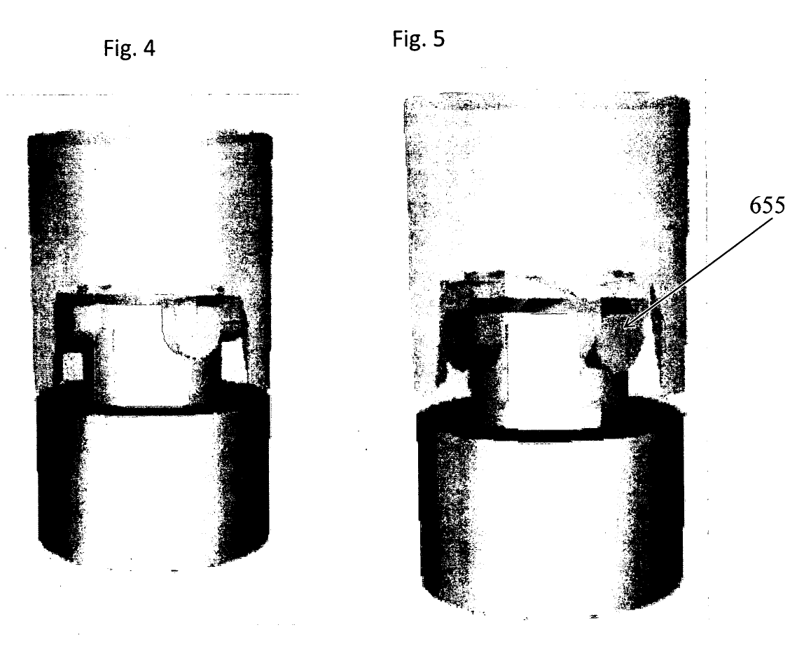

FIGS. 2, 3, 4, and 5 illustrate the first leg moving into the first support, and at various stages along the path. As can be seen, the first prong 185 translates vertically in a first axial direction between FIGS. 1 and 2, and then translates laterally, while continuing the vertical translation in the first axial direction between FIGS. 2 and 3 and on into FIG. 4. At FIG. 4, the first prong has reached the end of the first portion, and then translates axially in a second axial direction between FIGS. 4 and 5. The second direction substantially opposes the first axial direction. Having moved in the second axial direction, the lateral translation of the prong is substantially reduced.

In one embodiment, a spring or other biasing member biases the prong against axial translation in the first axial direction after moving in the second axial direction. The spring, in one embodiment, exerts force between the first support and first leg. In another embodiment, the spring is disposed within the reception hole and exerts axial force on the male portion. In another embodiment, a spring biases a lock substantially restricting movement in the first axial direction after moving in the second axial direction.

FIG. 6 illustrates one embodiment of a method 600 for a method for assembling a television stand, in accordance with one aspect of the invention. Method 600 begins at 610 by receiving at least a first leg in a reception hole of a first support. Step 610 is partially illustrated in FIGS. 1 and 2. Method 600 continues at 620 by translating the first leg along a first portion in a first axial direction and a lateral direction, as seen in FIGS. 2, 3, and 4. Additionally, method 600, at step 630, translates the first leg along a second portion in a second axial direction, the second axial direction substantially opposing the first axial direction, and wherein the second portion substantially restricts lateral translation as seen in FIGS. 4 and 5. In one embodiment, translating the first leg along the first portion includes receiving at least a first prong in the first portion; and guiding the first prong from a start of the first portion to the start of the second portion. FIG. 6 illustrates the prong in its destination position 655.

Another aspect of the invention provides for a method of selling a television stand. This method includes manufacturing a leg configured to be inserted directly into a support surface by translating axially in a first axial direction and laterally along a first portion to translate axially in a second portion in a second axial direction such that the first axial direction opposes the second axial direction. The method further includes manufacturing a support portion configured to guide the manufactured leg to translate axially in a second portion in a second axial direction such that the first axial direction opposes the second axial direction. The leg and support portion are packaged and distributed to consumers without tools or other fasteners.

Another aspect of the invention provides for a disassembled television stand in a box. The disassembled television stand in a box consists of a container holding a predetermined number of support portions configured to guide a leg to translate axially in a second portion in a second axial direction such that the first axial direction opposes the second axial direction and a predetermined number of legs configured to translate axially in a second portion in a second axial direction such that the first axial direction opposes the second axial direction. Another aspect of the invention provides for a disassembled television stand in a box, such that the box consists of a container holding at least one set of directions and a predetermined number of support portions configured to guide a leg to translate axially in a second portion in a second axial direction such that the first axial direction opposes the second axial direction and a predetermined number of legs configured to translate axially in a second portion in a second axial direction such that the first axial direction opposes the second axial direction.

Another embodiment of the invention provides for a television stand including at least three legs and at least two support surfaces. Each support surface includes at least one leg hole configured to receive the legs. The legs are inserted into and through the leg holes and attached using at least one threaded support.

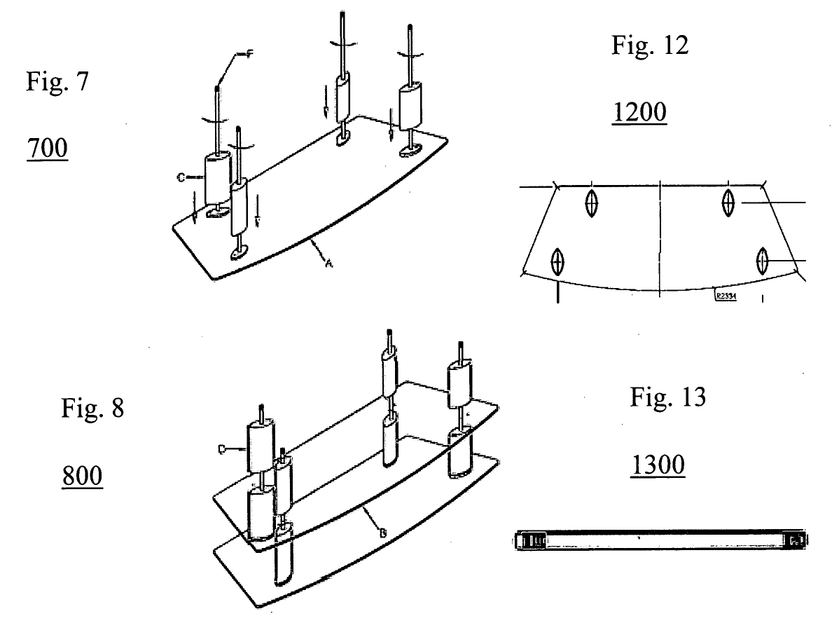

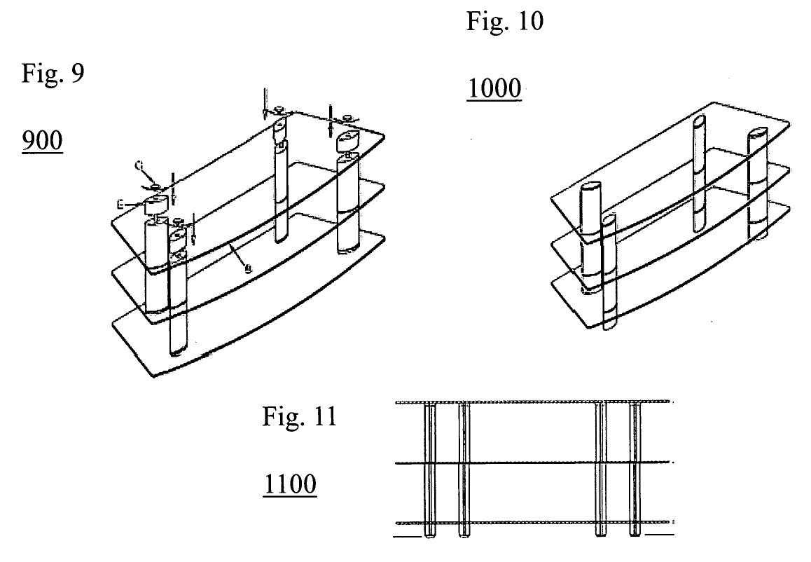

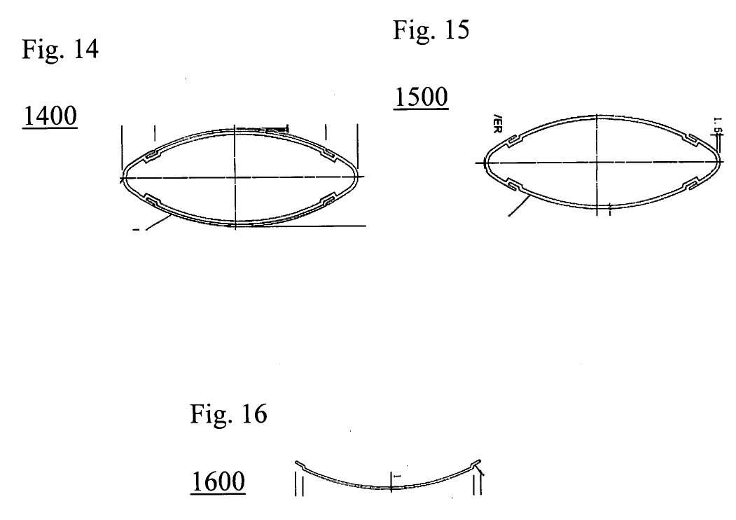

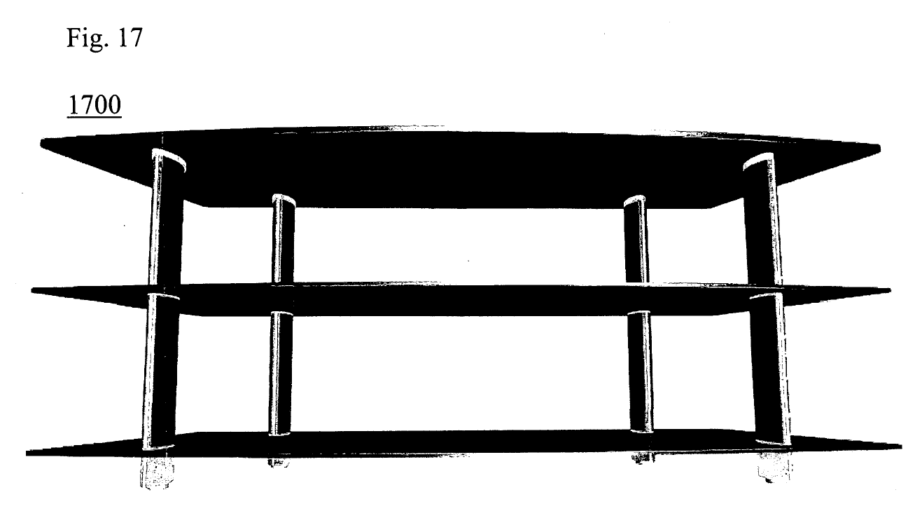

FIGS. 7-16 illustrate assembly drawings for a television stand and assembly instructions for a television stand in accordance with the invention. In particular, FIGS. 7 and 8 illustrate methods of attaching legs to a support surface. FIG. 9 illustrates another step in an assembly process, and FIG. 10 is a schematic view of an assembled television stand. FIG. 11 is a side view of an assembled television stand, FIG. 12 is a top view of a support surface, and FIG. 13 is a side view of a shaft for connecting the legs to a support surface. FIGS. 14-15 are cross sectional views of a leg, and FIG. 16 is a cross sectional view of a cover for a leg in accordance with other aspects of the invention.

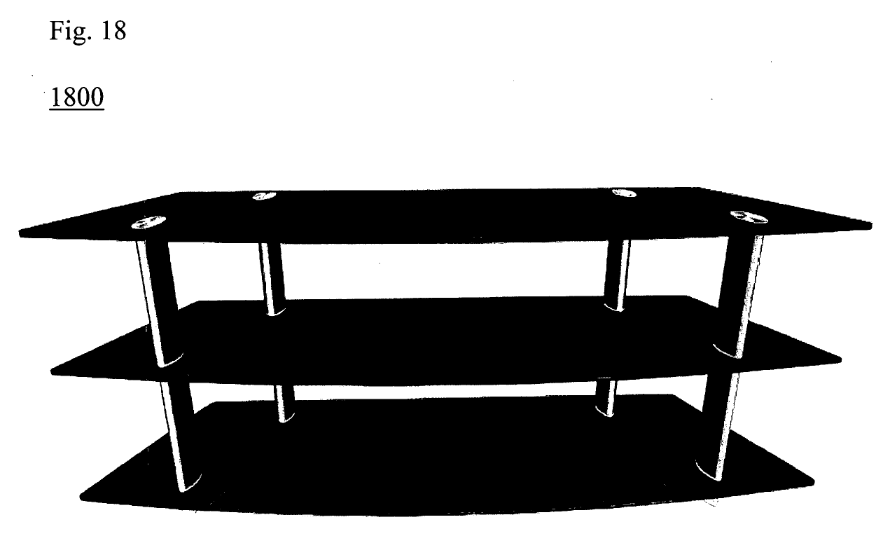

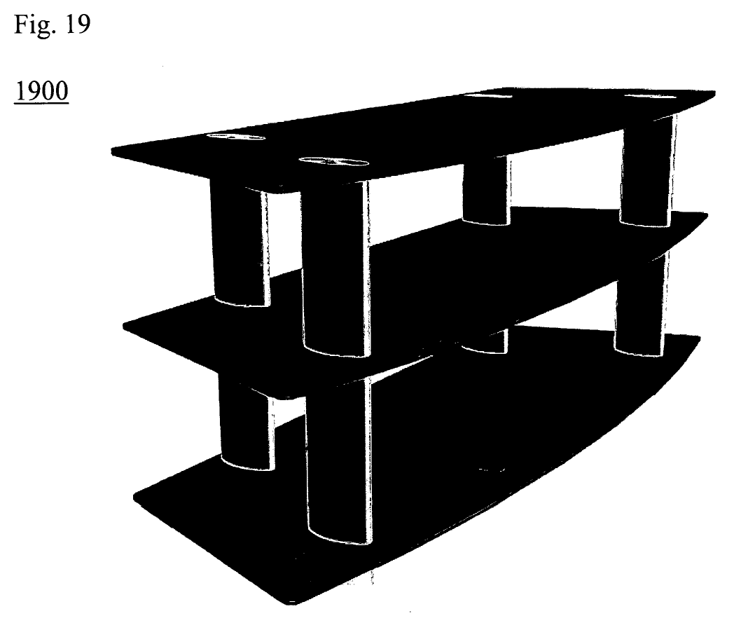

FIGS. 17-19 illustrate perspective views of a television stand assembled in accordance with the invention.

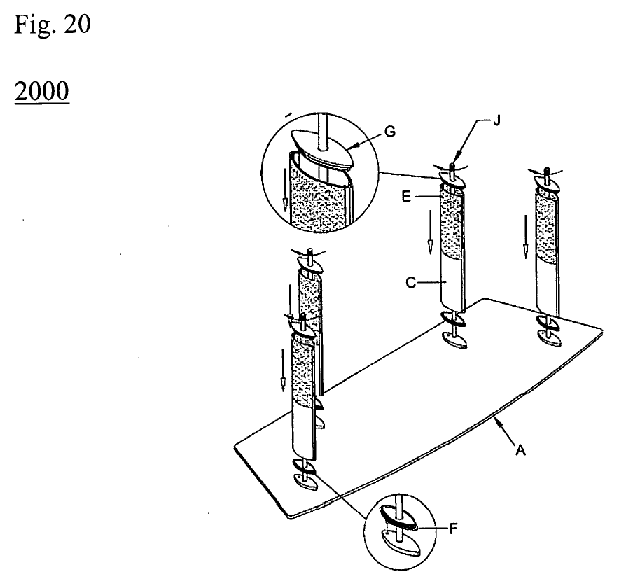

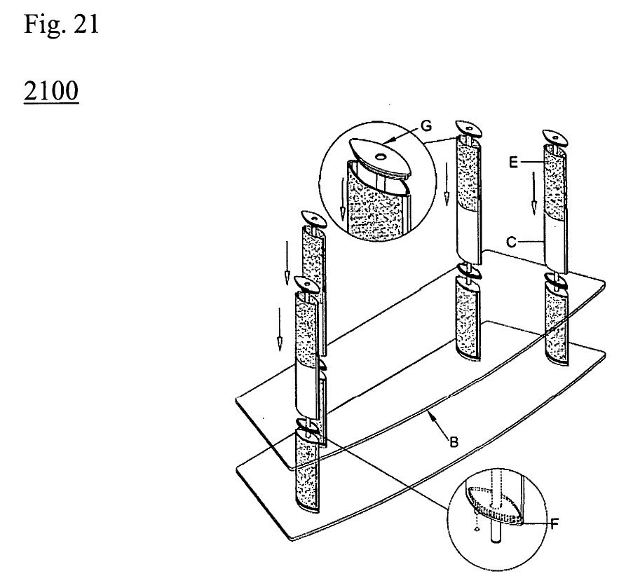

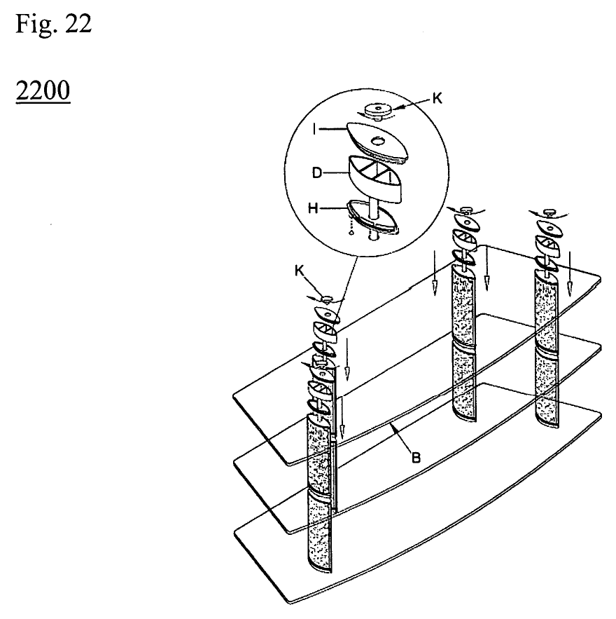

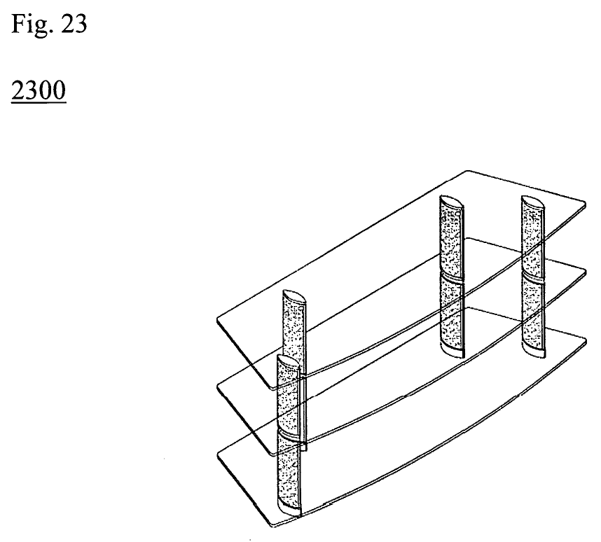

FIGS. 20-23 illustrate assembly drawings for a television stand in accordance with another embodiment of the invention. As illustrated in FIGS. 20-23, the legs include a different cover device, and provide for interchangeable covers, such as different colors, textures or the like. As shown in FIGS. 20-23, the legs wherein include a cover portion to mate with at least one interchangeable cover. Thus, the appearance of the television stand can be modified to color match a decor, match a personal color preference, display affinity colors (such as those of a university or a sports team or the like), and can even be swapped out at a user's discretion. The interchangeable covers can be included in a package, or sold separately.

Those of skill in the art will recognize that the disclosures herein provide for a television stand that does not require tools or separate tool-operated implements for assembly. Therefore, the television stand can be more easily assembled by a consumer, and can assist in reducing costs by reducing the number of pieces, such as screws or tools, that need to be included in a package.

The attached figures illustrate various features of the invention. Other variations and combinations of features will be apparent to those with skill in the art. Those variations are included within the disclosure herein.

1. A stand for a television, the stand comprising:
a first support including a planar surface and a base surface opposing the planar surface, the base surface including a plurality of reception holes, wherein each reception hole includes at least a first portion and second portion, the first portion in fluidic communication with the second portion and an ambient environment, the first portion defining a first portion axis and the second portion defining a second portion axis such that the first portion axis defines an angle with respect to the second portion axis that is greater than zero and less than 180 degrees; and
at least a first leg, the leg including a male portion at a first end of the first leg, the first leg comprising a first diameter and the male portion including a second diameter, the second diameter smaller than the first diameter, the second diameter sized to fit within at least one of the reception holes, and wherein the male portion includes at least a first prong extending radially from the male portion, the first prong sized to translate axially and laterally along the first portion and axially along the second portion.

2. The stand of claim 1 wherein the reception hole further comprises at least a third portion, the third portion in fluidic communication with the first portion, and wherein the third portion includes a third portion axis, the third portion axis defining an angle with respect to the first portion axis that is greater than zero and less than 180 degrees.

3. The stand of claim 2 wherein the second portion axis is substantially parallel with the third portion axis.

4. The stand of claim 1 wherein the male portion further comprises a second prong, the first prong and second prong spaced apart from each other, and wherein the first prong defines a first prong axis substantially perpendicular to the first leg axis, and the second prong defines a second prong axis substantially perpendicular to the first leg axis, and wherein the second prong is sized to translate axially and laterally along the first portion and axially along the second portion.

5. The stand of claim 1 wherein the first portion axis and second portion axis defines an angle between 45 degrees and 90 degrees.

6. The stand of claim 5 wherein the second portion translates the first prong from a first position to a second position laterally offset from the first position and wherein the destination position substantially restricts lateral movement of the prong.

7. The stand of claim 6 further comprising a locking member configured to fit in a space defined between the first support and the first leg at the first diameter when the first prong is in the destination position.

8. The stand of claim 1 wherein the second portion translates the first prong from a first position to a second position laterally offset from the first position and wherein the destination position substantially restricts lateral movement of the prong.

9. The stand of claim 8 further comprising a locking member configured to fit in a space defined between the first support and the first leg at the first diameter when the first prong is in the destination position.

10. The stand of claim 1 wherein the at least one leg includes a cover portion to mate with at least one interchangeable cover.

11. A television stand comprising:
a first portion including a reception hole; and
a second portion including a male portion sized to fit within the reception hole, and wherein the second portion is rotated by contact between the male portion and reception hole as the second portion is axially moved into the reception hole.

12. The television stand of claim 11 wherein the male portion includes at least one prong extending radially from the male portion and wherein the reception hole includes a first portion, a second portion, and a third portion, and wherein the prong is sized to translate axially in a first direction along the third portion, axially and laterally along the second portion, and axially along the third portion in a second direction, wherein the first direction substantially opposes the second direction.

13 The television stand of claim 12 wherein the first portion defines an first portion axis, and wherein the second portion defines a second portion axis, and wherein the first portion defines a first portion axis, and wherein the first portion axis defines an angle greater than 0 degrees and less than 180 degrees with respect to the third portion axis, and wherein the first portion axis defines an angle greater than 0 degrees and less than 180 degrees with respect to the second portion axis, and wherein the second portion axis and third portion axis are substantially parallel.

14 The television stand of claim 13 wherein the first portion axis defines an angle greater than 20 degrees and less than 160 degrees with respect to the third portion axis, and wherein the first portion axis defines an angle greater than 20 degrees and less than 160 degrees with respect to the second portion axis.

15 The television stand of claim 13 wherein the first portion axis defines an angle approximately equal to 45 degrees with respect to the third portion axis, and wherein the first portion axis defines an angle approximately equal to 45 degrees with respect to the second portion axis.

16. The television stand of claim 11 further comprising a cover portion to mate with at least one interchangeable cover.

17. A method for assembling a television stand, the method comprising:
receiving at least a first leg in a reception hole of a first support;
translating the first leg along a first portion in a first axial direction and a lateral direction; and
translating the first leg along a second portion in a second axial direction, the second axial direction substantially opposing the first axial direction, and wherein the second portion substantially restricts lateral translation.

18. The method of claim 15 wherein translating the first leg along the first portion comprises:
receiving at least a first prong in the first portion; and
guiding the first prong from a start of the first portion to the start of the second portion.
